(19) United States
(12) Patent Application Publication
(10) Pub. No.: US 2024/0356065 A1
(43) Pub. Date: Oct. 24, 2024

(54) Sulfide-based solid electrolyte including boron and method of manufacturing THE same

(71) Applicants: Hyundai Motor Company, Seoul (KR); Kia Corporation, Seoul (KR); Korea Institute of Science and Technology, Seoul (KR)

(72) Inventors: Ho Cheol Shin, Seoul (KR); Hong Seok Min, Yongin (KR); Sang Heon Lee, Yongin (KR); Sang Soo Lee, Goyang (KR); Mun Seok Chae, Busan (KR); Wo Dum Jung, Seoul (KR); In Woo Song, Gwacheon (KR); So Young Kim, Jeongeup (KR); Young Whan Cho, Seoul (KR)

(21) Appl. No.: 18/367,414

(22) Filed: Sep. 12, 2023

(30) Foreign Application Priority Data
Apr. 18, 2023 (KR) 10-2023-0050691

(51) Int. Cl. H01M 10/0562; C01B 17/22

(52) U.S. Cl. CPC H01M 10/0562; C01B 17/22; C01P 2002/72; C01P 2002/76; C01P 2006/40; H01M 2300/008

(57) ABSTRACT

Disclosed are a sulfide-based solid electrolyte including boron and having a face-centered cubic crystalline phase and a method of manufacturing the same.

### CROSS-REFERENCE TO RELATED APPLICATION

This application claims, under 35 U.S.C. § 119(a), the benefit of priority from Korean Patent Application No. 10-2023-0050691, filed on Apr. 18, 2023, the entire contents of which are incorporated herein by reference.

### TECHNICAL FIELD

The present disclosure relates to a sulfide-based solid electrolyte including boron and having a face-centered cubic crystalline phase and a method of manufacturing the same.

### BACKGROUND

Recently, secondary batteries have been widely used in large devices such as vehicles, power storage systems, etc. as well as small devices such as mobile phones, camcorders, laptop computers, etc.

As the fields of application of secondary batteries have been widening, there is an increasing demand for batteries with improved safety and high performance.

Among secondary batteries, a lithium secondary battery has advantages of high energy density and large capacity per unit area compared to a nickel-manganese battery or a nickel-cadmium battery. However, most electrolytes used in conventional lithium secondary batteries are liquid electrolytes including organic solvents, etc. Hence, safety issues such as electrolyte leakage and the risk of fire due thereto have been constantly raised.

Accordingly, interest in an all-solid-state battery using a solid electrolyte rather than a liquid electrolyte as an electrolyte used to increase the safety of a lithium secondary battery has recently increased. Since a solid electrolyte is incombustible or flame retardant, it is much safer than the liquid electrolyte.

Solid electrolytes include oxide-based and sulfide-based solid electrolytes. Compared to oxide-based solid electrolytes, sulfide-based solid electrolytes have high lithium ion conductivity and are stable over a wide voltage range.

Among sulfide-based solid electrolytes, argyrodite-type Li_{7-y}PS_{6-y}X_{y} (1≤y≤1.7, X=at least one selected from among Cl, Br, and I) has been receiving attention due to high lithium ion conductivity at room temperature. However, Li_{7-y}PS_{6-y}X_{y} has a limitation in that it shows high lithium ion conductivity only when raw materials thereof are uniformly mixed and then allowed to react at a high temperature in an inert atmosphere.

### SUMMARY

In preferred aspects, provided are a sulfide-based solid electrolyte exhibiting high lithium ion conductivity at room temperature without high-temperature heat treatment and a method of manufacturing the same.

In one aspect, provided is a sulfide-based solid electrolyte including lithium (Li), boron (B), and a halogen element and including at least one crystalline phase. In particular, the crystalline phase may include a face-centered cubic (FCC) structure.

The term “face-centered cubic (FCC) structure” as used herein refers to a type of atomic arrangement in a cubic lattice with the face positions fully equivalent to each of the eight corners. In other words, in an FCC unit cell, the cubic lattice contains atoms at all the corners of the crystal lattice and at the center of all the faces of the cube such that the atom presents at the face-centered is shared between 2 adjacent unit cells and only ½ of each atom belongs to an individual cell. The FCC structure is often highly (tightly) packed (e.g., atomic packing factor of 0.74). For example, a symmetry “F-43m” space group as used herein and ordinarily understood in the art refers to a cubic symmetry having face centered orthorhombic lattices as well defined in Hermann-Mauguin notation.

The crystalline phase may have a space group of F-43m.

The crystalline phase may further include one or more selected from the group consisting of an α-Li₃PS₄ phase, a β-Li₃PS₄ phase, and a γ-Li₃PS₄ phase.

The sulfide-based solid electrolyte may further include an amorphous phase between crystalline phases.

The sulfide-based solid electrolyte may include an amount of about 10 wt % to 90 wt % of the crystalline phase, based on the total weight of the sulfide-based solid electrolyte.

The sulfide-based solid electrolyte may show diffraction peaks at diffraction angles of 2θ=15.5°±0.5°, 18.0°±0.5°, 25.0°±0.5°, 30.0°±0.5°, 31.0°±0.5°, 39.5°±0.5°, 44.5°±0.5°, 47.5°±0.5°, 52.0°±0.5°, and 54.5°±0.5° in an XRD spectrum using CuKα rays.

The sulfide-based solid electrolyte may include a compound represented by Chemical Formula 1 below.

(Li₃PS₄)·a(LiBH₄)·b(LiX) [Chemical Formula 1]

X may include F, Cl, Br, or I, with 1≤a≤6 and 0<b≤4.

The sulfide-based solid electrolyte may include a compound represented by Chemical Formula 2 below.

(Li₃PS₄)·c(LiBH₄)·d(LiX1)·e(LiX2) [Chemical Formula 2]

X1 and X2 may include different halogen elements, and each X1 and X2 may independently include F, Cl, Br, or I, with 1≤c≤6, 0<d≤2, and 0<e≤2.

The sulfide-based solid electrolyte may have lithium ion conductivity of about 5 mS/cm or more measured at a temperature of about 20° C. to 30° C.

In an aspect, provided is a method of manufacturing a sulfide-based solid electrolyte, including preparing a starting material including Li₃PS₄, LiBH₄, and LiX1 (in which X1 includes F, Cl, Br, or I) and obtaining a sulfide-based solid electrolyte by pulverizing the starting material.

The starting material may further include LiX2, X2 includes a halogen element different from X1, and X2 includes F, Cl, Br, or I.

The obtaining the sulfide-based solid electrolyte may include subjecting the starting material to milling using a ball mill at about 500 rpm to 800 rpm for about 1 minute to 10 minutes and resting for about 1 minute to 5 minutes.

The obtaining the sulfide-based solid electrolyte may include repeating the milling and resting about 10 to 20 times.

In another aspect, provided is a battery (e.g., all-solid-state battery) including the sulfide-based solid electrolyte as described herein.

Still the disclosure provides a vehicle that include the battery including the sulfide-based solid electrolyte as described herein.

Other aspects of the invention are disclosed infra.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows results of X-ray diffraction analysis of a sulfide-based solid electrolyte according to Example 1;

FIG. 2 shows results of X-ray diffraction analysis of a sulfide-based solid electrolyte according to Example 5; and

FIG. 3 shows results of X-ray diffraction analysis of a sulfide-based solid electrolyte according to Example 10.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5% 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. If a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular”, “automotive” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In an aspect, the disclosure provides a sulfide-based solid electrolyte including lithium (Li), boron (B), and a halogen element.

Particularly, a sulfide-based solid electrolyte according to a first embodiment may include a compound represented by Chemical Formula 1 below:

(Li₃PS₄)·a(LiBH₄)·b(LiX) [Chemical Formula 1]
wherein X may include F, Cl, Br, or I, with 1≤a≤6 and 0<b≤4.

A sulfide-based solid electrolyte according to an exemplary embodiment may include a compound represented by Chemical Formula 2 below:

(Li₃PS₄)·c(LiBH₄)·d(LiX1)·e(LiX2) [Chemical Formula 2]
wherein X1 and X2 include different halogen elements, and X1 and X2 each may independently include F, Cl, Br, or I, with 1≤c≤6, 0<d≤2, and 0<e≤2.

The sulfide-based solid electrolyte may include at least one crystalline phase. For example, the sulfide-based solid electrolyte may include a first crystalline phase and a second crystalline phase.

The first crystalline phase may include a face-centered cubic (FCC) structure. The face-centered cubic structure may be configured such that 6 face-centered atoms form an octahedron (O) and a tetrahedron (T) exists on both sides thereof. Accordingly, lithium ions (Li⁺) may move in a tetrahedron-octahedron-tetrahedron path within the face-centered cubic structure.

The first crystalline phase may have a space group of F-43m.

The second crystalline phase may include one or more selected from the group consisting of an α-Li₃PS₄ phase, a β-Li₃PS₄ phase, and a γ-Li₃PS₄ phase, and preferably includes a β-Li₃PS₄ phase. The α-Li₃PS₄ phase has a structure in which a LiS₄ tetrahedron and another LiS₄ tetrahedron share any one vertex, so that a total of four LiS₄ tetrahedrons is connected to each other, and one LiS₄ tetrahedron shares a vertex with two PS₄ tetrahedrons. The β-Li₃PS₄ phase exhibits high lithium ion conductivity because PS₄ tetrahedrons are arranged in a zigzag pattern, providing space for lithium ions in both the octahedral site and the tetrahedral site. The γ-Li₃PS₄ phase is stable at low temperatures because PS₄ tetrahedrons are arranged in the same direction and the LiS₄ and PS₄ tetrahedrons are arranged in the same direction. The β-Li₃PS₄ phase may show peaks in positions of at least 2θ=13.5°±0.5°, 17.5°±0.5°, 18.1°±0.5°, 19.8°±0.5°, 26.0°±0.5°, 27.4°±0.5°, 29.0°±0.5°, 29.8°±0.5°, 31.1° 0.5°, 39.3°±0.5°, 40.4°±0.5°, 44.9°±0.5°, and 47.6°±0.5° in the XRD spectrum using CuKα rays.

The sulfide-based solid electrolyte may include the crystalline phase in an amount of about 10 wt % to 90 wt %, about 20 wt % to 90 wt %, about 30 wt % to 90 wt %, about 40 wt % to 90 wt %, about 50 wt % to 90 wt %, about 60 wt % to 90 wt %, about 70 wt % to 90 wt %, or about 80 wt % to 90 wt %, all the wt % are based on the total weight of the sulfide-based solid electrolyte. Among crystalline phases of the sulfide-based solid electrolyte, the first crystalline phase may be dominant.

The sulfide-based solid electrolyte may further include an amorphous phase between the crystalline phases. Lithium ion conductivity of the sulfide-based solid electrolyte may be further increased by including a small amount of an amorphous phase in which lithium ions may move efficiently between the ordered crystalline phases.

The sulfide-based solid electrolyte may show diffraction peaks at diffraction angles of 2θ=15.5°±0.5°, 18.0°±0.5°, 25.0°±0.5°, 30.0°±0.5°, 31.0°±0.5°, 39.5°±0.5°, 44.5°±0.5°, 47.5°±0.5°, 52.0°±0.5°, and 54.5°±0.5° in the XRD spectrum using CuKα rays. The diffraction peaks may originate from the compound represented by Chemical Formula 1 or Chemical Formula 2, and may originate from Li₃PS₄ remaining partially after being used as a raw material for the compound.

The sulfide-based solid electrolyte may have lithium ion conductivity of about 5 mS/cm or more measured at a temperature of about 20° C. to 30° C. The upper limit of the lithium ion conductivity is not particularly limited, and may be, for example, about 20 mS/cm or less.

The method of manufacturing the sulfide-based solid electrolyte may include preparing a starting material including Li₃PS₄, LiBH₄, and LiX1 (in which X1 includes F, Cl, Br, or I) and obtaining a sulfide-based solid electrolyte by pulverizing the starting material.

The starting material may further include LiX2 (in which X2 includes a halogen element different from X1, and X2 includes F, Cl, Br, or I).

The amount of each component constituting the starting material may be appropriately adjusted so as to be suitable for the compound represented by Chemical Formula 1 or Chemical Formula 2 described above.

The technical feature of the present disclosure is that a sulfide-based solid electrolyte having high lithium ion conductivity at room temperature is realized even without high-temperature heat treatment of the starting material by appropriately adjusting the amounts of LiBH₄, LiX1, and LiX2 in the starting material.

Obtaining the sulfide-based solid electrolyte may include subjecting the starting material to milling at about 500 rpm to 800 rpm for about 1 minute to 10 minutes using a ball mill and resting for about 1 minute to 5 minutes.

The type of ball mill is not particularly limited, and may include, for example, a planetary mill, a vibration mill, an attrition mill, a tumbling mill, and the like.

The ball milling may be performed in a state in which the starting material is sealed. Specifically, milling may be performed in a state in which the inside of the ball mill is filled with an inert gas such as argon gas or nitrogen gas and the ball mill is sealed.

Obtaining the sulfide-based solid electrolyte may include repeating the milling and resting about 10 to 20 times.

### EXAMPLE

A better understanding of the present disclosure may be obtained through the following examples. These examples are merely set forth to illustrate the present disclosure, and are not to be construed as limiting the scope of the present disclosure.

### Example 1

In a glove box, 1.034 g of lithium sulfide (Li₂S) and 1.667 g of phosphorus pentasulfide (P₂S₅) were placed along with 45 zirconia balls having a diameter of 10 mm in a 125 ml container made of zirconia and the container was covered with a lid and sealed. The container was mounted on a planetary mill (Retsch PM200), after which milling at about 650 rpm for about 5 minutes and then cooling for about 5 minutes were repeated 12 times, thus synthesizing Li₃PS₄.

The container was placed again in the glove box and opened, after which 0.653 g of LiBH₄ and 0.318 g of LiCl were added into the container, and the container was covered with a lid and sealed. The container was mounted on a planetary mill, after which milling at about 650 rpm for about 5 minutes and then cooling for about 5 minutes were repeated 18 times, thereby synthesizing a solid-based solid electrolyte.

The container was placed again in the glove box and opened, and the sulfide-based solid electrolyte was collected.

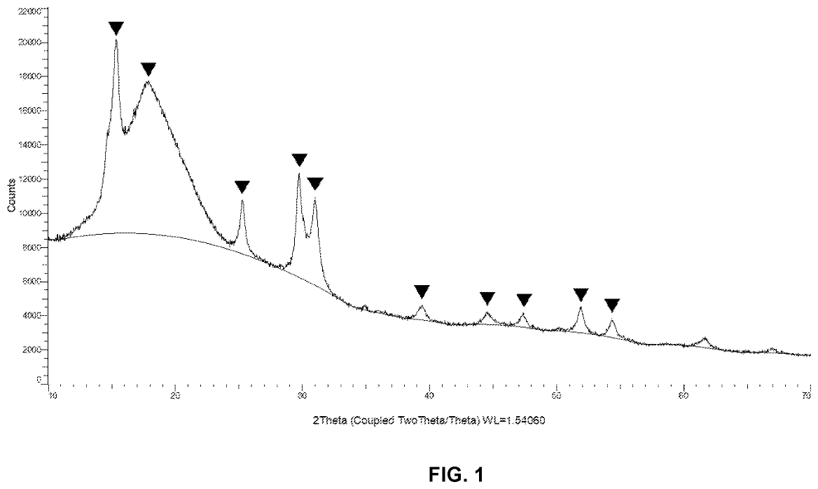

FIG. 1 shows results of X-ray diffraction analysis of the sulfide-based solid electrolyte according to Example 1. The sulfide-based solid electrolyte according to Example 1 shows diffraction peaks at diffraction angles of 2θ=15.5°, 17.9°, 25.2°, 29.7°, 30.9°, 34.9°, 39.5°, 44.6°, 47.5°, 51.9°, 54.4°, 61.8°, 66.9°, etc. in the XRD spectrum. These are mostly deemed to be due to the first crystalline phase having a face-centered cubic structure, indicating that a sulfide-based solid electrolyte predominantly having a face-centered cubic structure according to the present disclosure can be obtained.

### Example 2

A sulfide-based solid electrolyte was synthesized in the same manner as in Example 1, with the exception that 0.653 g of LiBH₄ and 0.651 g of LiBr were added.

### Example 3

A sulfide-based solid electrolyte was synthesized in the same manner as in Example 1, with the exception that 0.653 g of LiBH₄ and 0.5°2 g of LiI were added.

### Example 4

A sulfide-based solid electrolyte was synthesized in the same manner as in Example 1, with the exception that 0.449 g of LiBH₄ and 0.477 g of LiCl were added.

### Example 5

A sulfide-based solid electrolyte was synthesized in the same manner as in Example 1, with the exception that 0.327 g of LiBH₄ and 0.636 g of LiCl were added.

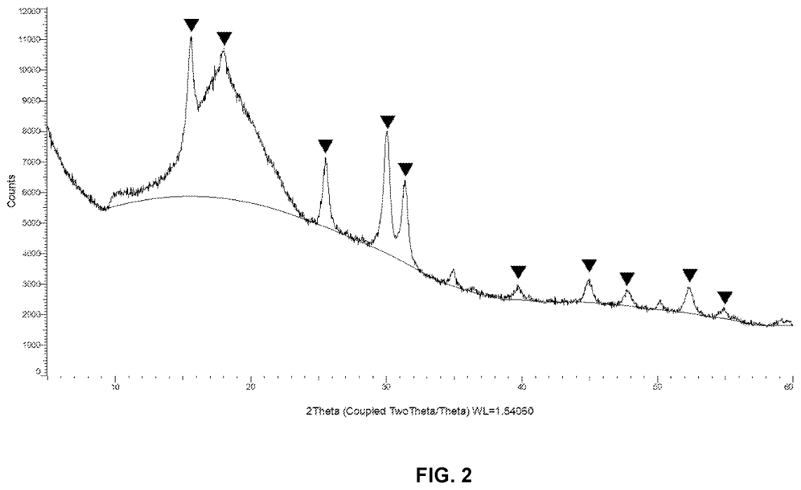

FIG. 2 shows results of X-ray diffraction analysis of the sulfide-based solid electrolyte according to Example 5. The sulfide-based solid electrolyte according to Example 5 shows diffraction peaks at diffraction angles of 2θ=9.9°, 15.6°, 18.0°, 25.5°, 30.1°, 31.2°, 34.9°, 36.3°, 39.8°, 44.9°, 47.8°, 50.2°, 52.3°, 54.9°, 59°, etc. in the XRD spectrum. These are mostly deemed to be due to the first crystalline phase having a face-centered cubic structure, indicating that a sulfide-based solid electrolyte predominantly having a face-centered cubic structure according to the present disclosure can be obtained.

### Example 6

A sulfide-based solid electrolyte was synthesized in the same manner as in Example 1, with the exception that 0.653 g of LiBH₄, 0.318 g of LiCl, and 0.194 g of LiF were added.

### Example 7

A sulfide-based solid electrolyte was synthesized in the same manner as in Example 1, with the exception that 0.327 g of LiBH₄, 0.0477 g of LiCl, and 0.326 g of LiBr were added.

### Example 8

A sulfide-based solid electrolyte was synthesized in the same manner as in Example 1, with the exception that 0.490 g of LiBH₄, 0.318 g of LiCl, and 1.004 g of LiI were added.

### Example 9

A sulfide-based solid electrolyte was synthesized in the same manner as in Example 1, with the exception that 0.572 g of LiBH₄, 0.636 g of LiCl, and 0.778 g of LiF were added.

### Example 10

A sulfide-based solid electrolyte was synthesized in the same manner as in Example 1, with the exception that 0.653 g of LiBH₄ and 0.194 g of LiF were added.

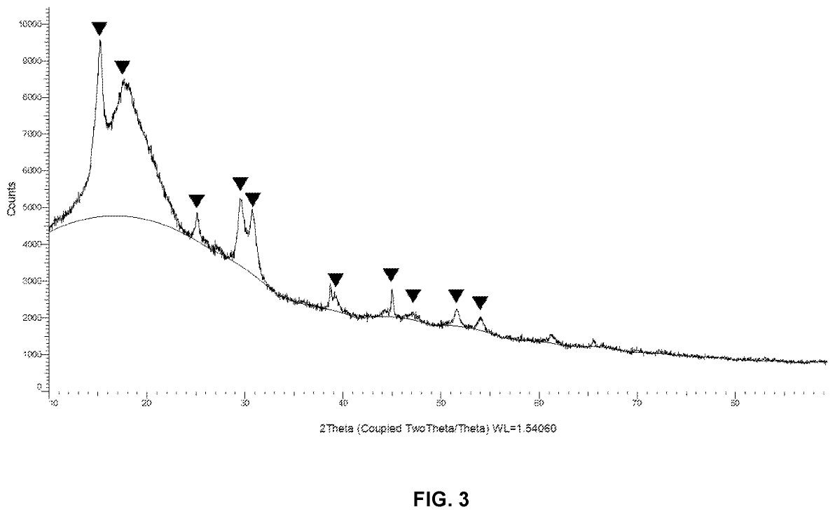

FIG. 3 shows results of X-ray diffraction analysis of the sulfide-based solid electrolyte according to Example 10. The sulfide-based solid electrolyte according to Example 10 shows diffraction peaks at diffraction angles of 2θ=15.1°, 17.5°, 18.1°, 25.0°, 27.1°, 29.5°, 30.8°, 38.6°, 39.1°, 45.0°, 47.0°, 51.5°, 54.0°, 61.1°, 65.6°, etc. in the XRD spectrum. These are mostly deemed to be due to the first crystalline phase having a face-centered cubic structure, indicating that a sulfide-based solid electrolyte predominantly having a face-centered cubic structure according to the present disclosure can be obtained.

### Comparative Example 1

A sulfide-based solid electrolyte was synthesized in the same manner as in Example 1, with the exception that 0.194 g of LiF was added.

### Comparative Example 2

A sulfide-based solid electrolyte was synthesized in the same manner as in Example 1, with the exception that 0.327 g of LiBH₄ was added.

### Comparative Example 3

A sulfide-based solid electrolyte was synthesized in the same manner as in Example 1, with the exception that 0.954 g of LiCl was added.

### Comparative Example 4

A sulfide-based solid electrolyte was synthesized in the same manner as in Example 1, with the exception that 0.636 g of LiCl and 0.651 g of LiBr were added.

The compositions of Examples 1 to 10 and Comparative Examples 1 to 4 are summarized in Table 1 below.

A sample in a pellet form was prepared by pressing the sulfide-based solid electrolyte of each of Examples 1 to 10 and Comparative Examples 1 to 4. A symmetric cell was prepared by placing electrodes on both sides of the sample. A Nyquist plot was determined by measuring the impedance of the symmetric cell using an impedance analyzer, and lithium ion conductivity was calculated therefrom. The above experiments were performed at about 25° C. in an argon atmosphere. Table 1 below shows the lithium ion conductivity of each sulfide-based solid electrolyte.

TABLE 1

| | | Measurement | Lithium ion |
|---|---|---|---|
| | | temperature | conductivity |
| Classification | Composition | [° C.] | [mS/cm] |
| Example 1 | (Li₃PS₄)•2(LiBH₄)•0.5(LiCl) | 25.3 | 16.4 |
| Example 2 | (Li₃PS₄)•2(LiBH₄)•0.5(LiBr) | 25.3 | 12.5 |
| Example 3 | (Li₃PS₄)•2(LiBH₄)•0.25(LiI) | 25.3 | 11.4 |
| Example 4 | (Li₃PS₄)•1.375(LiBH₄)•0.75(LiCl) | 25.3 | 10.3 |
| Example 5 | (Li₃PS₄)•(LiBH₄)•(LiCl) | 25.2 | 6.4 |
| Example 6 | (Li₃PS₄)•2(LiBH₄)•0.5(LiCl)•0.5(LiF) | 25.8 | 16.6 |
| Example 7 | (Li₃PS₄)•(LiBH₄)•0.75(LiCl)•0.25(LiBr) | 25.3 | 6.7 |
| Example 8 | (Li₃PS₄)•1.5(LiBH₄)•0.5(LiCl)•0.5(LiI) | 25.3 | 11.7 |
| Example 9 | (Li₃PS₄)•1.75(LiBH₄)•(LiCl)•2(LiF) | 25.3 | 10.5 |
| Example 10 | (Li₃PS₄)•2(LiBH₄)•0.5(LiF) | 24.5 | 8.9 |
| Comparative | (Li₃PS₄)•0.5(LiF) | 24.4 | 0.6 |
| Example 1 | | | |
| Comparative | (Li₃PS₄)•(LiBH₄) | 25.6 | 2.1 |
| Example 2 | | | |
| Comparative | (Li₃PS₄)•1.5(LiCl) | 25.3 | 0.4 |
| Example 3 | | | |
| Comparative | (Li₃PS₄)•(LiCl)•0.5(LiBr) | 25.3 | 0.4 |
| Example 4 | | | |

As shown in Table 1, the sulfide-based solid electrolytes according to Examples 1 to 10 all had lithium ion conductivity measured at room temperature exceeding 6 mS/cm, and lithium ion conductivity thereof was mostly greater than 10 mS/cm. In particular, Example 1 and Example 6 exhibited very high lithium ion conductivity exceeding 16 mS/cm. In contrast, lithium ion conductivity of the sulfide-based solid electrolytes according to Comparative Examples 1 to 4 was much lower than that of Examples.

As is apparent from the above description, according to various exemplary embodiments of the present disclosure, a sulfide-based solid electrolyte exhibiting high lithium ion conductivity at room temperature without high-temperature heat treatment and a method of manufacturing the same can be provided.

The effects of the present disclosure are not limited to the above-mentioned effects. It should be understood that the effects of the present disclosure include all effects that can be inferred from the description of the present disclosure.

As the test examples and examples of the present disclosure have been described in detail above, the scope of the present disclosure is not limited to the above-described test examples and examples, and various modifications and improvements made by those skilled in the art using the basic concept of the present disclosure defined in the following claims are also within the scope of the present disclosure.

What is claimed is:

1. A sulfide-based solid electrolyte comprising lithium (Li), boron (B), and a halogen element,
wherein the sulfide-based solid electrolyte comprises at least one crystalline phase,
wherein the crystalline phase comprises a face-centered cubic (FCC) structure.

2. The sulfide-based solid electrolyte of claim 1, wherein the crystalline phase has a space group of F-43m.

3. The sulfide-based solid electrolyte of claim 1, wherein the crystalline phase further comprises one or more selected from the group consisting of an α-Li₃PS₄ phase, a β-Li₃PS₄ phase, and a γ-Li₃PS₄ phase.

4. The sulfide-based solid electrolyte of claim 1, further comprising an amorphous phase between crystalline phases.

5. The sulfide-based solid electrolyte of claim 1, comprising an amount of about 10 wt % to 90 wt % of the crystalline phase, based on the total weight of the sulfide-based solid electrolyte.

6. The sulfide-based solid electrolyte of claim 1, wherein the sulfide-based solid electrolyte shows diffraction peaks at diffraction angles of 2θ=15.5°±0.5°, 18.0°±0.5°, 25.0°±0.5°, 30.0°±0.5°, 31.0°±0.5°, 39.5°±0.5°, 44.5°±0.5°, 47.5°±0.5°, 52.0°±0.5°, and 54.5°±0.5° in an XRD spectrum using CuKα rays.

7. The sulfide-based solid electrolyte of claim 1, comprising a compound represented by Chemical Formula 1 below:
(Li₃PS₄)·a(LiBH₄)·b(LiX) [Chemical Formula 1]
wherein X comprises F, Cl, Br, or I, with 1≤a≤6 and 0<b≤4.

8. The sulfide-based solid electrolyte of claim 1, comprising a compound represented by Chemical Formula 2 below:
(Li₃PS₄)·c(LiBH₄)·d(LiX1)·e(LiX2) [Chemical Formula 2]
wherein X1 and X2 comprise different halogen elements, and each X1 and X2 independently comprises F, Cl, Br, or I, with 1≤c≤6, 0<d≤2, and 0<e≤2.

9. The sulfide-based solid electrolyte of claim 1, wherein the sulfide-based solid electrolyte has lithium ion conductivity of about 5 mS/cm or greater measured at a temperature of about 20° C. to 30° C.

10. A method of manufacturing a sulfide-based solid electrolyte, comprising:
preparing a starting material comprising Li₃PS₄, LiBH₄, and LiX1, wherein X1 comprises F, Cl, Br, or I; and
obtaining a sulfide-based solid electrolyte by pulverizing the starting material,
wherein the sulfide-based solid electrolyte comprises lithium (Li), boron (B), and a halogen element and comprises at least one crystalline phase, and the crystalline phase comprises a face-centered cubic (FCC) structure.

11. The method of claim 9, wherein the starting material further comprises LiX2, wherein X2 comprises a halogen element different from X1, and X2 comprises F, Cl, Br, or I.

12. The method of claim 9, wherein obtaining the sulfide-based solid electrolyte comprises subjecting the starting material to milling using a ball mill at about 500 rpm to 800 rpm for about 1 minute to 10 minutes and resting for about 1 minute to 5 minutes.

13. The method of claim 11, wherein obtaining the sulfide-based solid electrolyte comprises repeating milling and resting about 10 to 20 times.

14. The method of claim 11, wherein the crystalline phase has a space group of F-43m.

15. The method of claim 9, wherein the crystalline phase further comprises one or more selected from the group consisting of an α-Li₃PS₄ phase, a β-Li₃PS₄ phase, and a γ-Li₃PS₄ phase.

16. The method of claim 9, wherein the sulfide-based solid electrolyte further comprises an amorphous phase between crystalline phases.

17. The method of claim 9, wherein the sulfide-based solid electrolyte comprises an amount of about 10 wt % to 90 wt % of the crystalline phase, based on the total weight of the sulfide-based solid electrolyte.

18. The method of claim 9, wherein the sulfide-based solid electrolyte shows diffraction peaks at diffraction angles of 2θ=15.5°±0.5°, 18.0°±0.5°, 25.0°±0.5°, 30.0°±0.5°, 31.0° 0.5°, 39.5°±0.5°, 44.5°±0.5°, 47.5°±0.5°, 52.0°±0.5°, and 54.5°±0.5° in an XRD spectrum using CuKα rays.

19. The method of claim 9, wherein the sulfide-based solid electrolyte comprises a compound represented by Chemical Formula 1 below:
(Li₃PS₄)·a(LiBH₄)·b(LiX) [Chemical Formula 1]
wherein X is independently F, Cl, Br, or I, with 1≤a≤6 and 0<b≤4.

20. The method of claim 9, wherein the sulfide-based solid electrolyte comprises a compound represented by Chemical Formula 2 below:
(Li₃PS₄)·c(LiBH₄)·d(LiX1)·e(LiX2) [Chemical Formula 2]
wherein X1 and X2 comprise different halogens, and each X1 and X2 independently comprises F, Cl, Br, or I, with 1≤c≤6, 0<d≤2, and 0<e≤2.
